(19) United States
(12) Patent Application Publication
(10) Pub. No.: US 2005/0288420 A1
(43) Pub. Date: Dec. 29, 2005

(54) Method for preparing reactive formulations of macrocyclic oligomers

(76) Inventors: Michael Steven Paquette, Midland, MI (US); Robert Paul Dion, Midland, MI (US); Peter Charles LeBaron, Midland, MI (US); Robert Louis Sammler, Midland, MI (US)

Correspondence Address: GARY C. COHN, PLLC, 1147 NORTH FOURTH STREET, UNIT 6E, PHILADELPHIA, PA, 19123, US

(21) Appl. No.: 11/154,017

(22) Filed: Jun. 16, 2005

Related U.S. Application Data
(60) Provisional application No. 60/581,187, filed on Jun. 18, 2004.

(51) Int. Cl. C08K 3/34

(52) U.S. Cl. 524/445

(57) ABSTRACT

Dispersions of filler particles and macrocyclic oligomers are prepared in the presence of a solvent for the macrocyclic oligomer. The use of the solvent facilitates easier and more complete dispersion of the filler particles into the macrocyclic oligomer, improving the efficiency of the filler, reducing thermal degradation of the filler and oligomer, and reducing energy requirements.

### CROSS-REFERENCE TO RELATED APPLICATION

This application claims benefit of U.S. Provisional Application Nos. 60/581,187 and 60/581,188, both filed 18 Jun. 2004.

### BACKGROUND OF THE INVENTION

The invention relates to polymers derived from macrocyclic oligomers containing organoclay fillers. Furthermore, the invention relates to articles prepared from nanodispersions of a clay filler in a macrocyclic oligomer.

Macrocyclic oligomers have been developed which form polymeric compositions with desirable properties such as strength, toughness, high gloss and solvent resistance. Among preferred macrocyclic oligomers are macrocyclic polyester oligomers such as those disclosed in U.S. Pat. No. 5,498,651, incorporated herein by reference. Such macrocyclic polyester oligomers are excellent starting materials for producing polymer composites because they exhibit low melt viscosities, which facilitate good impregnation and wet out in composite applications. Furthermore, such macrocyclic oligomers are easy to process using conventional processing techniques. However, such polymer compositions do not have heat deflection temperatures that are high enough to permit them to be suitable for some high-temperature applications. Therefore, nanocomposites of such materials have been developed wherein layered clay platelets are dispersed in the polymeric matrix. Such compositions are disclosed in U.S. Pat. No. 5,530,052, and in PCT application PCT/US03/041476, filed Dec. 19, 2003, both incorporated herein by reference.

The dispersed clays in these nanocomposites provide improved thermal properties and reinforcement to the polymer, while other properties such as ductility are maintained at acceptable values. This property enhancement depends greatly on the extent to which the clay becomes exfoliated and distributed uniformly throughout the polymer. Therefore, methods by which the clay particles can be distributed efficiently and more evenly throughout the polymer matrix are highly desirable.

### SUMMARY OF THE INVENTION

In one aspect, this invention is a process for preparing a dispersion of filler particles in a macrocyclic oligomer, comprising

a) combining filler particles, macrocyclic oligomer and a solvent for the macrocyclic oligomer, under conditions such that the macrocyclic oligomer becomes dissolved in the solvent, to form a mixture of filler particles dispersed in the macrocyclic oligomer and solvent, and

b) polymerizing the macrocyclic oligomer in the presence of the dispersed filler particles.

This process provides a method by which excellent dispersion of the filler particles into the polymer phase can be achieved. In the preferred cases where the filler particle is a layered material such as a clay, the excellent dispersion in turn allows for a higher degree of exfoliation of the clay within the polymer matrix, resulting in very efficient reinforcement and other desirable physical and thermal properties. In particular, reduced degradation of the clay and the macrocyclic oligomer is sometimes seen when the dispersion and composite are made in the manner of this invention, because initial mixing of the filler particles into the macrocyclic oligomer can be conducted at lower temperature, lower shear conditions than previous processes. In preferred cases where the filler particles are a clay that is treated with an organic onium ion, the thermal degradation of the onium ion can also be reduced.

It is also believed that in preferred embodiments the presence of the solvent causes the clay to swell, increasing inter-layer spacing. The larger inter-layer spacing is believed to provide more room for the macrocyclic oligomer to penetrate between the clay layers and polymerize therein. In this manner, greater exfoliation of the clay is believed to occur, leading to more efficient distribution of the clay and more efficient reinforcement of the resulting composite.

### DETAILED DESCRIPTION OF THE INVENTION

The dispersion of the invention is prepared by combining the filler particles, macrocyclic oligomer and a solvent. The order of addition of filler particles, macrocyclic oligomer and solvent is not critical. In one variation of the process, the filler particles and solvent are combined and mixed to disperse the filler particles into the solvent. This is conveniently performed at any temperature at which the solvent is a liquid. A temperature of from about 0-40° C., especially from about 20-35° C. is generally suitable. The filler/solvent mixture is then agitated to achieve an initial dispersion of the filler into the solvent. If desired, this agitation can be performed under more intensive conditions so that the filler particles form a non-settling, more homogenous dispersion in the solvent. At least a portion of layered fillers such as the preferred clay fillers may become partially or fully intercalated or exfoliated during this treatment. The filler/solvent dispersion is then combined with macrocyclic oligomer. As the macrocyclic oligomer is typically a solid material at room temperature, it may be necessary to heat it in order to blend it with the filler/solvent dispersion and dissolve into the solvent. This may be accomplished by melting the macrocyclic oligomer and combining the molten macrocyclic oligomer with the filler/solvent dispersion, taking care to maintain the temperature sufficiently high that the macrocyclic oligomer remains as a liquid until the blending is completed. Alternatively, the macrocyclic oligomer may be added to the filler/solvent dispersion as a solid, preferably particulate, material, and the entire composition is then heated if necessary to melt the macrocyclic oligomer. The mixture is then agitated to disperse the filler into the oligomer. Dissolution of the oligomer into the solvent is indicated by the formation of a single phase containing both solvent and oligomer.

The filler particles may be in principle any particulate filler, but the advantages of the invention are especially seen when the filler is in the form of submicron-sized particles, or is a layered material that can be partially or fully exfoliated into sub-micron sized particles. Particles having a smallest dimension of about 0.6 nanometers or greater and preferably about 1 nanometer or greater, up to about 50 nanometers, more preferably up to about 20 nanometers, and especially up to about 10 nanometers. The particles may have a largest dimension of up to 1 micron or more. Particle sizes in this invention refer to volume average particle sizes of the dispersed filler particles, measured using an appropriate analytical method such as transmission electron spectroscopy, not simply to the as-received filler, which may be in the form of aggregate primary particles, or may have a layered structure that is often subdivided into smaller materials during the process of making the masterbatch and/or composite.

Preferably, the filler particles have an aspect ratio of about 10 or greater, more preferably about 100 or greater and most preferably about 500 or greater. “Aspect ratio” as used herein means the length of the largest dimension of a platelet or fiber divided by the smallest dimension, which is preferably the platelet or fiber thickness.

Raw materials (filler, solvent, macrocyclic oligomer and other optional additives) that contain water or volatile impurities are preferably dried prior to forming the mixture of filler particles, solvent, additives and macrocyclic oligomer.

Several variations to the foregoing method can be used. In one such variation, the macrocyclic oligomer is first dissolved into the solvent, and the filler particles are dispersed into the resulting macrocyclic oligomer solution.

In a second variation, the filler particles, solvent and macrocyclic oligomer are all combined together, heated to a temperature sufficient to dissolve the macrocyclic oligomer, and the resulting mixture is mixed as before.

In a third variation, a dispersion of the filler particles in the solvent is formed, as is a separate solution of the macrocyclic oligomers in an additional quantity of the solvent. The filler/solvent dispersion and the macrocyclic oligomer solution are blended and the resulting blend is mixed as before. The macrocyclic oligomer solution can be added to the filler/solvent dispersion as a liquid, by first heating (if necessary) the solution above its melting temperature. Alternatively, if the macrocyclic oligomer solution is a solid at room temperature (˜22° C.), it can be dispersed as a particulate solid into the filler/solvent dispersion, and the resulting mixture may be heated if needed to form the blend. This approach permits initial filler processing at a lower viscosity, lower temperature environment, and allows the filler and macrocyclic oligomer solutions to be mixed in a relatively low viscosity, low temperature environment.

In any of the foregoing approaches, any material can be added to another continuously, intermittently or incrementally.

The resulting product is a physical dispersion of the filler particles in a solution of the macrocyclic oligomer. In preferred embodiments in which the filler is a layered clay material, it is believed that solvent and/or macrocyclic oligomer will intercalate the clay to some extent during the mixing process. However, this is not necessarily the case and the clay may be distributed in the form of aggregated primary particles with little exfoliation. A suitable concentration of filler particles is from about 1-20% by weight, based on combined weight of the filler particles, macrocyclic oligomers and any optional co-monomer, chain extender, polymer, impact modifier or rubber, as described more below. This level of filler particles provides good reinforcement and thermal properties (such as heat distortion) in the polymer. It is usually not necessary to use more than about 10% or about 7% by weight of the filler particles, particularly when the filler particles have particles sizes as described above. A particularly preferred amount of filler particles is about 2-6% by weight in cases where the filler is a layered clay. However, if the blend is to be used as a masterbatch, and is to be subsequently blended with additional macrocyclic oligomer (or another polymerizable or polymeric material) prior to or during the polymerization step, filler particle concentrations can be up to 60%, such as from about 21-60% or 25-50% by weight, again based on the weight of the filler particles, macrocyclic oligomers and any optional co-monomer, chain extender, polymer, impact modifier or rubber, as described more fully below.

The amount of solvent can range significantly to provide a desirable concentration of the macrocyclic oligomers (and any optional co-monomers, crosslinkers or modifiers) in the solution. A suitable concentration of solvent is from about 1 to 95% of the combined weight of the solvent, macrocyclic oligomers, and any co-monomer, chain extender, polymer, impact modifier or rubber that may be present. A more suitable concentration thereof is about 10-80% by weight. An especially suitable concentration is about 25-75% by weight, particularly in cases where the dispersion is polymerized in the presence of the solvent, as described more below. It is possible to practice the invention by forming a somewhat dilute blend of filler and macrocyclic oligomer in the solvent, and then letting the blend down into more macrocyclic oligomer prior to or during the polymerization step.

The dispersion can be used in different ways to form a composite. In one process, the solvent is removed to form a dispersion of the clay in the macrocyclic oligomer. This dispersion, which is a solid at room temperature, can be formed into a particulate by, for example, grinding or pelletizing methods. Solvent removal is conveniently done using conventional methods of decanting, drying, vacuum drying, distillation, vacuum distillation, devolatilization, filtration, extraction or combinations of these. The particular method will depend on the particular solvent that is used. Solvents having boiling temperatures of below 100° C. are conveniently removed via a drying, vacuum distillation, vacuum drying or devolatilization process. Extraction methods are of particular interest when the solvent is a higher boiling material. Extraction methods can be performed on the solidified or molten dispersion by contacting it with an extractant in which the solvent is miscible. The extractant is generally a volatile hydrocarbon, halocarbon or alcohol having a boiling temperature of below 100° C. The greater volatility of the extractant allows residual quantities of the extractant to be removed from the dispersion by exposing it to vacuum and/or moderately elevated temperatures. After solvent removal, the dispersion is suitable for use in various melt-processing procedures to make molded or shaped articles.

The resulting dispersion is then subjected to conditions sufficient to polymerize the macrocyclic oligomer. Methods of polymerizing cyclic oligomers are well known. Examples of such methods are described in U.S. Pat. Nos. 6,369,157 and 6,420,048, WO 03/080705 and U.S. Published application 2004/0011992, among many others. Any of these conventional polymerization methods are suitable for use with this invention. In general, the polymerization reaction is conducted at an elevated temperature in a presence of a polymerization catalyst as described below.

The polymerization is conducted above the melting temperature of the macrocyclic oligomer mixture. The particular temperature at which that condition is achieved will of course depend on the particular macrocyclic oligomer that is present. Suitable polymerization temperatures are from about 100° C. to about 300° C., with a temperature range of about 100° C. to about 280° C. being preferable and a temperature range of about 180-270° C. being especially preferred. The polymerizing mixture is maintained at the elevated temperature until the desired molecular weight and conversion are obtained.

The catalyst can be added during the polymerization or just prior to the polymerization. The catalyst may instead be incorporated into the filler/solvent/macrocyclic oligomer dispersion as it is prepared, by blending it into the solvent and/or macrocyclic oligomer (or an optional component). In some embodiments, this approach is thought to result in the intercalation of the catalyst within the layers of clay particles, and/or chemically bond to the clay. Chemical bonding of the catalyst to clay particles is believed to be favored when the clay contains or is treated with a material that contains active hydrogen-containing groups such as hydroxyl or amine groups. Clay treated with a hydroxyl-containing onium compound as described below is in particular believed to be capable of forming bonds to the polymerization catalyst.

The polymerization may be conducted in a closed mold to form a molded article. An advantage of cyclic oligomer polymerization processes is that they allow thermoplastic resin molding operations to be conducted using techniques that are generally applicable to thermosetting resins. When melted, the cyclic oligomer typically has a relatively low viscosity. This allows the cyclic oligomer to be used in reactive molding process such as liquid resin molding, reaction injection molding and resin transfer molding, as well as in processes such as resin film infusion, impregnation of fiber mats or fabrics, prepreg formation, pultrusion and filament winding that require the resin to penetrate between individual fibers of fiber bundles to form structural composites. Certain processes of these types are described in U.S. Pat. No. 6,420,047, incorporated herein by reference.

The resulting polymer must achieve a temperature below its crystallization temperature before it is demolded. Thus, it may be necessary to cool the polymer before demolding (or otherwise completing processing). In some instances, particularly in polymerizing cyclic butylene terephthalate oligomers, the melting and polymerization temperature of the oligomers is below the crystallization temperature of the resulting polymer. In such a case, the polymerization temperature is advantageously between the melting temperature of the oligomer and the crystallization temperature of the polymer. This allows the polymer to crystallize at the polymerization temperature (isothermal curing) as molecular weight increases. In such cases, it is not necessary to cool the polymer before demolding can occur.

The polymerization can also be conducted as a bulk polymerization to produce a particulate polymer (such as a pelletized polymer) that is useful for subsequent melt processing operations, such as extrusion, injection molding, compression molding, thermoforming, blow molding, resin transfer molding and the like.

The resulting polymerization product is a dispersion of the filler particles in the polymerized macrocyclic oligomer. A suitable concentration of filler particles is from about 1-20% by weight, based on combined weight of the clay, macrocyclic oligomers and any optional co-monomer, chain extender, polymer, impact modifier or rubber, as described more below. This level of filler provides good reinforcement and thermal properties (such heat distortion) in the polymer. It is usually not necessary to use more than about 10% or about 7% by weight of the filler, particularly when the filler is a preferred layered material such as a layered clay. A particularly preferred amount of layered clay particles is about 2-6% by weight.

In order to further distribute the filler, the filler/macrocyclic oligomer dispersion may be subjected to high shear conditions. This can be done at various stages of the process. For example, the mixture of filler, solvent and macrocyclic oligomer may be subjected to high shear conditions as they are being combined to create the dispersion. Alternatively, the dispersion may be subjected to shear subsequent to the formation step, either before or after the solvent is removed. The shearing may be performed immediately prior to or even during the polymerization step. Shearing may in addition be done during a blending step, in which the dispersion is blended with more macrocyclic oligomer, another polymerizable material, or another polymer. In preferred embodiments using a layered clay filler, the shearing will often at least partially exfoliate the clay, and thereby result in better distribution of clay particles within the polymer.

Shearing is conveniently performed using a high speed mixing blade, a single or twin-screw extruder, or other specialized mixing device that produces high shear. Shear rates of 10,000 reciprocal seconds or greater, such as 20,000-150,000 reciprocal seconds or from 30,000 to 100,000 reciprocal seconds are particularly useful. A variety of high shear mixing devices are useful. An example of a suitable high shear mixer is a serrated blade, commonly known as a Cowles blade, rotating so as to produce a tip speed of 2500 feet per minute or higher, such as from about 3000 to about 6000 feet per minute or about 3500 to about 5000 feet per minute. In the preferred embodiments, the shearing is continued for a time sufficient to intercalate clay particles, increasing the interlayer spacing as described before. A period of about 2 minutes or greater, more preferably about 10 minutes or greater and most preferably about 15 minutes or greater is generally sufficient. A period of no longer than about 90 minutes, such as about 40 minutes or less and most preferably about 25 minutes or less, is generally sufficient. Excessive shearing times may cause the filler particles and/or the macrocyclic oligomer to degrade.

Shearing is conveniently applied during melt processing operations using an extruder such as a twin screw extruder. Shear rates as described before are suitable. In this way, the shearing step can be performed at the same time the filler/macrocyclic oligomer dispersion is melt processed to form an article and/or combined with more macrocyclic oligomer or additional polymer or polymerizable material.

The shearing step is preferably done at a temperature at which the macrocyclic oligomer (and additional polymer or polymerizable oligomers) are fluids. Unless the shearing step is performed in the presence of the solvent, it will normally be necessary to conduct the shearing step at an elevated temperature. The temperature that is needed in any particular instance will of course depend on the particular macrocyclic oligomer and the relative proportions of solvent, macrocyclic oligomer and other polymers and/or polymerizable materials. The shearing step is suitably conducted below the boiling temperature of the solvent-temperatures of 22° C. to 300° C. are suitable depending on the solvent, with temperatures of 40-200° C. being preferred and 100-200° C. being especially preferred.

It is also within the scope of the invention to conduct a solution polymerization, in which the macrocyclic oligomer is polymerized in the presence of a solvent to form a dispersion of the clay in the resulting polymer. Such a solution polymerization is generally performed in bulk, to form a particulate or pelletized polymer that is useful for subsequent melt processing operations as described. The solvent may be the same solvent used to make the dispersion, although it is within the scope of the invention to substitute another solvent or to add additional solvent to supplement that supplied with the dispersion. The solvent should have a boiling temperature at or below the polymerization temperature. An advantage of the solution polymerization process is that lower temperatures are usually needed to melt the macrocyclic oligomer solution and thus conduct the polymerization, compared to neat polymerization processes. The lower temperatures can reduce filler and macrocyclic monomer degradation and reduce energy requirements. This is particularly the case in preferred embodiments where the filler is a layered clay or an onium-treated clay as described below. Suitable solution polymerization temperatures are from 100-270° C., such as from 100-220° C. or from 150-190° C. In general, it is preferred to use polymerization temperatures at 190° C. or below.

Depending on the amount of solvent that is present, the polymerization product may have a liquid continuous polymer/solvent phase, be a viscous, paste-like material, or even be a friable solid a room temperature. It is generally preferable that enough of the solvent is present so that the polymerizate is a liquid or pasty solid at the completion of the polymerization, as this facilitates solvent removal (together with removal of degradation products). After the solution polymerization is completed, the solvent can be removed from the resulting polymer using methods as described before, with an extraction method being particularly suitable. After solvent removal, the polymer is suitable for use in various melt-processing procedures to make molded or shaped articles.

The composite resulting from the polymerization may be further processed to increase its molecular weight. Two approaches to accomplishing this are solid state polymerization and chain extension. Solid state polymerization is achieved by postcuring the composite by exposing it to an elevated temperature. This may be done during melt-processing operations or in a subsequent step. A suitable postcuring temperature is from about 170° C., about 180° C., or about 195° C. up to about 220° C., about 210° C. or about 205° C., but below the melting temperature of the polymer phase of the composite. The solid state polymerization is preferably performed in a non-oxidizing environment such as under a nitrogen or argon atmosphere and is preferably performed under vacuum and/or flowing gas to remove volatile components. Postcuring time times of about 1-36 hours, such as from 4-30 hours or 12-24 hours, are generally suitable. Preferably, the macrocyclic oligomer is advanced to a weight average molecular weight of about 60,000 or greater, more preferably about 80,000 or greater and most preferably about 100,000 or greater. It is usually not necessary to use additional catalyst to obtain solid state advancement.

Chain extension is performed by contacting the composite with a polyfunctional chain extending agent. The polyfunctional chain extending agent contains two or more functional groups that react with functional groups on the polymerized macrocyclic oligomer to couple polymer chains and thus increase molecular weight. Suitable such polyfunctional chain extending agents are described more fully below. No additional catalyst is usually required and elevated temperatures as described hereinbefore are useful for the chain extension reaction.

Filler particles include, but are not limited to glass (including cloth, powders, microspheres and fibers); carbons and graphites including cloth, powders, platelets, fibers, and nanotubes; silicates including talc, feldspar, wollastonite and clays; hydroxides including alumina trihydrate and magnesium hydroxide; metals including powders, flake, fibers; ceramics including powders, platelets, whiskers and fibers; in addition to inorganic oxides, carbonates, sulfates, aluminates, aluminosilicates, stearates and borates. The filler particles may function as a colorant (such a pigment or dye), and/or may function as a catalyst, stabilizer or flame retardant. Filler particles can also include organic materials such as synthetic or natural polymer powders or fibers, cellulosic powders or fibers including wood, starch and cotton; as well as vegetable matter. Such fillers are used for replacing the more expensive polymer, for reinforcement and strengthening, for impact modification, for coloring, for improving the flammability resistance, for improving optical, electrical or magnetic properties, for mold release and various other improvements in cost, processability or performance.

Clays that are useful in this invention are minerals or synthetic materials having a layered structure, in which the individual layers are platelets or fibers with thicknesses in the range of 5-100 angstroms. Suitable clays include kaolinite, halloysite, serpentine, montmorillonite, beidellite, nontronite, hectorite, stevensite, saponite, illite, kenyaite, magadiite, muscovite, sauconite, vermiculite, volkonskoite, pyrophylite, mica, chlorite or smectite. Preferably, the clay comprises a natural or synthetic clay of the kaolinite, mica, vermiculite, hormite, illite or montmorillonite groups. Preferred kaolinite group clays include kaolinite, halloysite, dickite, nacrite and the like. Preferred montmorillonites include montmorillonite, nontronite, beidellite, hectorite, saponite bentonite and the like. Preferred minerals of the illite group include hydromicas, phengite, brammalite, glauconite, celadonite and the like. More preferably, the preferred layered minerals include those often referred to as 2:1 layered silicate minerals like muscovite, vermiculite, beidelite, saponite, bentonite, hectorite and montmorillonite, wherein montmorillonite is most preferred. Preferred minerals of the hormite group include sepiolite and attapulgite, where the layered structure is interrupted in one dimension resulting in fibrous or lath-like particle morphology.

In addition to the clays mentioned above, admixtures prepared therefrom may also be employed as well as accessory minerals including, for instance, quartz, biotite, limonite, hydrous micas, feldspar and the like. The layered minerals described above may be synthetically produced by a variety of processes, and are known as synthetic hectorites, saponites, montmorillonites, micas as well as their fluorinated analogs. Synthetic clays can be prepared via a number of methods which include the hydrolysis and hydration of silicates, gas solid reactions between talc and alkali fluorosilicates, high temperature melts of oxides and fluorides, hydrothermal reactions of fluorides and hydroxides, shale weathering as well as the action of acid clays and inorganic acids on primary silicates.

The clay is preferably modified with an organic onium compound, such as described in U.S. Pat. No. 5,707,439 and PCT/US03/041,476. This modification is believed to result from a cation exchange reaction between the organic onium compound and the native clay, substituting the organic onium compound for mainly alkali metal and alkaline earth cations present in the unmodified clay. The onium compound is a salt comprising a negatively-charged counter-ion and a positively-charged nitrogen, phosphorus or sulfur atom. Particularly useful onium compounds have at least one ligand with a five carbon atom or greater chain. Preferably, the onium compound has at least one ligand with a five carbon atom or greater chain and also contains at least one (and preferably two or more) other ligands containing a functional group having an active hydrogen atom that is capable of reacting with the macrocyclic oligomer during the polymerization reaction. The anion counterion in the onium compound can be any anion which forms a salt with an onium compound and which can be exchanged with an anionic species on the clay particle. Preferably the onium compound corresponds to the formula 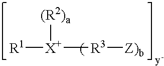
wherein R¹ is a C₅ or greater straight, alicyclic or branched chain hydrocarbyl group, R² is independently in each occurrence a C₁₋₂₀ hydrocarbyl group optionally containing one or more heteroatoms; R³ is a C₁₋₂₀ alkylene or cycloalkylene moiety; X is a nitrogen, phosphorus or sulfur; Z is an active hydrogen-atom containing functional group; a is separately in each occurrence an integer of 0, 1 or 2 and b is an integer of 1 to 3 wherein the sum of a+b is 2 where X is sulfur and 3 where X is nitrogen or phosphorus. More preferably X is nitrogen. More preferably, R¹ is a C₁₀₋₂₀ hydrocarbon chain; and most preferably a C₁₂₋₁₈ alkyl group. More preferably, R² is C₁₋₁₀ hydrocarbyl and most preferably C₁₋₃ alkyl. More preferably, R³ is C₁₋₁₀ alkylene and most preferably C₁₋₃ alkylene. More preferably, Z is a primary or secondary amine, thiol, hydroxyl, acid chloride or carboxylic acid, carboxylate ester or glycidyl group; even more preferably a primary amine or hydroxyl group and most preferably a hydroxyl group. More preferably, y is separately in each occurrence a halogen or sulfate ester (such as an alkyl sulfate like methyl sulfate), and most preferably chlorine or bromine. More preferably, a is an integer of 0 or 1, and most preferably 1. Most preferably, b is 2 or 3.

Other onium compounds that do not contain the active-hydrogen containing functional group can be used instead of or in combination with those described above. Suitable examples of these include those described in U.S. Pat. No. 5,530,052 and U.S. Pat. No. 5,707,439, incorporated herein by reference. When such non-functional onium compounds are used, they are preferably used in combination with the functional types. The onium compounds containing functional groups tend to act as initiation sites for polymerization of the macrocyclic oligomers. The presence of these initiation sites tends to increase the number of polymer chains that are formed, which in turn tends to reduce average molecular weight of the polymer. Using a mixture of the functional and non-functional types permits one to balance molecular weight effects with good dispersion of the clay into the polymer matrix. Preferably, the functional onium compound constitutes at least 1 weight percent or greater, such as at least 10 weight percent or at least 20 weight percent, about 100 percent by weight, such as up to about 90 weight percent or up to about 50 weight percent up to about 30 weight percent of all onium compounds used.

The onium compounds tend to enhance the ability of the catalyst and macrocyclic oligomer to intercalate the clay. Preferably, at least 50 percent, such as at least 75 percent or at least 90 percent, of the exchangeable cations on the clay are replaced with the onium compound. An excess of the onium compound, such as up to 1.5 equivalents or 1.25 equivalents of onium compound per equivalent of exchangeable cations, may be used.

The macrocyclic oligomer is a polymerizable cyclic material having two or more ester linkages in a ring structure. The ring structure containing the ester linkages includes at least 8 atoms that are bonded together to form the ring. The oligomer includes two or more structural repeat units that are connected through the ester linkages. The structural repeat units may be the same or different. The number of repeat units in the oligomer suitably ranges from about 2 to about 8. Commonly, the cyclic oligomer will include a mixture of materials having varying numbers of repeat units. A preferred class of cyclic oligomers is represented by the structure
—[O-A-O—C(O)—B—C(O)]_{y}— (I)
where A is a divalent alkyl, divalent cycloalkyl or divalent mono- or polyoxyalkylene group, B is a divalent aromatic or divalent alicyclic group, and y is a number from 2 to 8. The bonds indicated at the ends of structure I connect to form a ring. Examples of suitable macrocyclic oligomers corresponding to structure I include oligomers of 1,4-butylene terephthalate, 1,3-propylene terephthalate, 1,4-cyclohexenedimethylene terephthalate, ethylene terephthalate, and 1,2-ethylene-2,6-naphthalenedicarboxylate, and copolyester oligomers comprising two or more of these. The macrocyclic oligomer is preferably one having a melting temperature of below about 200° C. and preferably in the range of about 150-190° C. A particularly preferred cyclic oligomer is a cyclic 1,4-butylene terephthalate oligomer.

Suitable methods of preparing the cyclic oligomer are described in U.S. Pat. Nos. 5,039,783, 6,369,157 and 6,525,164, WO 02/18476, and WO 03/031059, all incorporated herein by reference. In general, cyclic oligomers are suitably prepared in the reaction of a diol with a diacid, diacid chloride or diester, or by depolymerization of a linear polyester. The method of preparing the cyclic oligomer is generally not critical to this invention. It is noted that the macrocyclic oligomer often goes through a purification step, such as an extraction process, to remove degradation products and other impurities. In this invention, it is possible to reduce or eliminate this purification step, as those degradation products and impurities are generally removed during the step of removing the solvent from the dispersion or the polymerized composite. As a result, lower-cost crude macrocyclic oligomers can in some instances be used in this invention.

The solvent is any which is compatible with the clay, and at least partially dissolves the macrocyclic oligomer at some temperature below the boiling temperature of the solvent. The solvent is preferably a liquid a room temperatures (˜22° C.). It may be relatively low boiling (such as at or below 100° C.), particularly if it is to be removed prior to polymerizing the macrocyclic oligomer. Alternatively, relatively high-boiling solvents can be used, particularly if a solution polymerization is to be performed. Such high boiling solvents include those having a boiling temperature of about 100 to about 300° C., especially from about 100 to about 200° C. The solvent should not be reactive with the macrocyclic oligomer or any optional co-monomer, chain extender, polymer, impact modifier or rubber that may be present. Suitable solvents include halogenated, especially chlorinated, hydrocarbons such as orthodichlorobenzene, aromatic and/or alkyl-substituted aromatic hydrocarbons, high boiling ethers and ketones.

The selection of the catalyst is driven by the nature of the macrocyclic oligomer. Tin- or titanate-based polymerization catalysts are of particular interest. Examples of such catalysts are described in U.S. Pat. No. 5,498,651 and U.S. Pat. No. 5,547,984, the disclosures of which are incorporated herein by reference. One or more catalysts may be used together or sequentially.

Illustrative classes of tin compounds that may be used in the invention include monoalkyltin hydroxide oxides, monoalkyltin chloride dihydroxides, dialkyltin oxides, bistrialkyltin oxides, monoalkyltin trisalkoxides, dialkyltin dialkoxides, trialkyltin, alkoxides, tin compounds having the formula 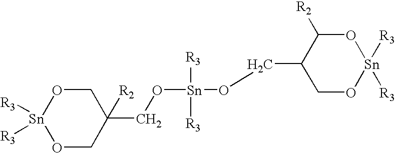
and tin compounds having the formula 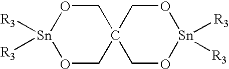
wherein R₂ is a C₁₋₄ primary alkyl group and R₃ is C₁₋₁₀ alkyl group. Specific examples of organotin compounds that may be used in this invention include 1,1,6,6-tetra-n-butyl-1,6-distanna-2,5,7-10-tetraoxacyclodecane, n-butyltinchloride dihydroxide, di-n-butyltin oxide, di-n-octyltin oxide, n-butyltin tri-n-butoxide, di-n-butyltin di-n-butoxide, 2,2-di-n-butyl-2-stanna-1,3-dioxacycloheptane, and tributyltin ethoxide. In addition, tin catalysts described in U.S. Pat. No. 6,420,047 (incorporated by reference) may be used in the polymerization reaction.

Titanate compounds that may be used in the invention include those described in U.S. Pat. No. 6,420,047 (incorporated by reference). Illustrative examples include tetraalkyl titanates (e.g., tetra(2-ethylhexyl) titanate, tetraisopropyl titanate, and tetrabutyl titanate), isopropyl titanate, titanate tetraalkoxide. Other illustrative examples include (a) titanate compounds having the formula 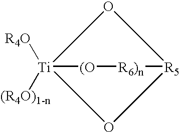
wherein each R₄ is independently an alkyl group, or the two R₄ groups taken together form a divalent aliphatic hydrocarbon group; R₅ is a C₂₋₁₀ divalent or trivalent aliphatic hydrocarbon group; R₆ is a methylene or ethylene group; and n is 0 or 1, (b) titanate ester compounds having at least one moiety of the formula 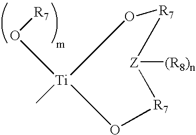
wherein each R₇ is independently a C₂₋₃ alkylene group; Z is O or N; R₈ is a C₁₋₆ alkyl group or unsubstituted or substituted phenyl group; provided when Z is O, m-n-0, and when Z is N, m=0 or 1 and m+n=1, and (c) titanate ester compounds having at least one moiety of the formula 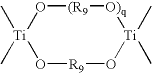
wherein each R₉ is independently a C₂₋₆ alkylene group; and q is 0 or 1.

Other suitable polymerization catalysts can be represented as
RₙQ₍₃₋ₙ₎Sn—O—X (I)
where n is 2 or 3, each R is independently an inertly substituted hydrocarbyl group, Q is an anionic ligand, and X is a group having a tin, zinc, aluminum or titanium atom bonded directed to the adjacent oxygen atom. Suitable X groups include —SnRₙQ₍₃₋ₙ₎, where R, Q and n are as described before; —ZnQ, where Q is as described before, —Ti(Q)₃, where Q is as described before, and —AlRₚ(Q)₍₂₋ₚ₎, where R is as described before and p is zero, 1 or 2. Preferred Q groups include —OR groups, where R is as described above. When X is SnRₙQ₍₃₋ₙ₎, R and/or OR groups may be divalent radicals that form ring structures including one or more of the tin or other metal atoms in the catalyst. Preferred X groups are —SnRₙQ₍₃₋ₙ₎, —Ti(OR)₃ and —AlRₚ(OR)₍₂₋ₚ₎. n is preferably 1 or 2. These catalysts are described in more detail in U.S. Provisional Application 60/564,552, filed Apr. 22, 2004. Examples of particular polymerization catalysts of this type include 1,3-dichloro-1,1,3,3-tetrabutyldistannoxane; 1,3-dibromo-1,1,3,3-tetrabutyldistannoxane; 1,3-difloro-1,1,3,3-tetrabutyldistannoxane; 1,3-diacetyl-1,1,3,3-tetrabutyldistannoxane; 1-chloro-3-methoxy-1,1,3,3-tetrabutyldistannoxane; 1,3-methoxy-1,1,3,3-tetrabutyl distannoxane; 1,3-ethoxy-1,1,3,3-tetrabutyldistannoxane; 1,3-(1,2-glycolate)-1,1,3,3-tetrabutyldistannoxane; 1,3-dichloro-1,1,3,3-tetraphenyldistannoxane; (n-butyl)₂(ethoxy)Sn—O—Al(ethoxide)₂, (n-butyl)₂(methoxy)Sn—O—Zn(methoxide), (n-butyl)₂(i-propoxy)Sn—O—Ti(i-propoxide)₃, (n-butyl)₃Sn—O—Al(ethyl)₂, (t-butyl)₂(ethoxy)Sn—O—Al(ethoxide)₂, and the like. Suitable distannoxane catalysts (i.e., where m is zero and X is —SnRₙQ₍₃₋ₙ₎) are described in U.S. Pat. No. 6,350,850, incorporated herein by reference.

Enough catalyst is provided to provide a desirable polymerization rate and to obtain the desired conversion of oligomers to polymer, but it is usually desirable to avoid using excessive amounts of catalyst. The mole ratio of catalyst to macrocyclic oligomer can range from about 0.01 mole percent or greater, more preferably from about 0.1 mole percent or greater and more preferably 0.2 mole percent or greater. The mole ratio of catalyst to macrocyclic oligomer is from about 10 mole percent or less, more preferably 2 mole percent or less, even more preferably about 1 mole percent or less and most preferably 0.6 mole percent or less.

Various additional materials may be incorporated into the dispersion or combined with the dispersion prior to or during its polymerization. Additional macrocyclic oligomer can be added to the clay/macrocyclic oligomer dispersion if desired. This will generally be the case where the dispersion is a masterbatch having a higher concentration of filler particles than needed in the final product. In addition, the polymerization may be conducted in the presence of various chain extenders, co-monomers and modifiers to produce various modified polymers. These materials may be incorporated into the dispersion during the preparation step described above, or added to the dispersion just prior to or during the polymerization step.

One such material is a copolymerizable monomer, other than a macrocyclic oligomer, which will copolymerize with the macrocyclic oligomer to for a random or block copolymer. Suitable copolymerizable monomers include cyclic esters such as lactones. The lactone conveniently contains a 4-7 member ring containing one or more ester linkages. The lactone may be substituted or unsubstituted. Suitable substituent groups include halogen, alkyl, aryl, alkoxyl, cyano, ether, sulfide or tertiary amine groups. Substituent groups preferably are not reactive with an ester group in such a way that the co-monomer will function as an initiator compound. Examples of such copolymerizable monomers include glycolide, dioxanone, 1,4-dioxane-2,3-dione, ε-caprolactone, tetramethyl glycolide, β-butyrolactone, lactide, γ-butyrolactone and pivalolactone.

Another optional material that may be included in the masterbatch is a polyfunctional chain extending compound having two or more functional groups which will react with functional groups on the polymerized macrocyclic oligomer (and/or another polymer in the blend). Examples of suitable functional groups are epoxy, isocyanate, ester, hydroxyl, carboxylic acid, carboxylic acid anhydride or carboxylic acid halide groups. More preferably, the functional groups are isocyanate or epoxy, with epoxy functional groups being most preferred. Preferred epoxy-containing chain extenders are aliphatic or aromatic glycidyl ethers. Preferable isocyanate-containing chain extenders include both aromatic and aliphatic diisocyanates. Preferably, the chain extender has about 2 to about 4, more preferably about 2 to about 3 and most preferably about 2 such functional groups per molecule, on average. The chain extender material suitably has an equivalent weight per functional group of 500 or less. A suitable amount of chain extender provides, for example, at least 0.25 mole of functional groups per mole of reactive groups in the polymerized macrocyclic oligomer.

The masterbatch may also include one or more polymeric materials which will form a polymer blend with the polymerized macrocyclic oligomer during its subsequent polymerization. Examples of such polymeric materials include, for example, polyesters such as poly(ε-caprolactam), polybutylene terephthalate, polyethylene adipate, polyethylene terephthalate and the like, polyamides, polycarbonates, polyurethanes, polyether polyols, polyester polyols, and amine-functional polyethers and/or polyesters. Polyolefins (such as polymers and interpolymers of ethylene, propylene, a butylene isomer and/or other polymerizable alkenes) that contain functional groups that react with functional groups on the polymerized macrocyclic oligomer and/or a chain extending agent can be used. Other polymeric materials that are compatible with the macrocyclic oligomer and/or the polymerized macrocyclic oligomer or contain functional groups that permit them to be coupled to the polymerized macrocyclic oligomer are also useful. Certain of these polymers may engage in transesterification reactions with the macrocyclic oligomer or its polymer during the polymerization process, to form block copolymers. Polymeric materials having reactive functional groups may be coupled to the polymerized macrocyclic oligomer with chain extenders as described above. Suitable functionalized polymeric materials contain about 1 or more, more preferably about 2 to about 3 and most preferably about 2 such functional groups per molecule, on average, and have an equivalent weight per functional group of greater than 500. Their molecular weights are suitably up to about 100,000, such as up to about 20,000 or up to about 10,000. Preferably, the polymeric material has a glass transition temperature significantly lower (such at least 10° C. lower or at least 30° C. lower) than the glass transition temperature of the polymerized macrocyclic oligomer alone. The lower glass transition temperature polymeric materials tend to improve the ductility and impact resistance of the resulting product. The functionalized polymer can contain any backbone which achieves the desired results of this invention. An especially suitable polyfunctional polymer is a polyether or polyester polyol.

Another suitable additional material is an impact modifier. Any impact modifier which improves the impact properties and toughness of the polymer composition may be used. Examples of impact modifiers include core-shell rubbers, olefinic toughening agents, block copolymers of monovinylidene aromatic compounds and alkadienes and ethylene-propylene diene monomer based polymers. The impact modifiers can be unfunctionalized or functionalized with polar functional groups. Suitable core shell rubbers include functionalized core shell rubbers having surface functional groups that react with the macrocyclic oligomer or functional groups on the polymerized macrocyclic oligomers. Preferred functional groups are glycidyl ether moieties or glycidyl acrylate moieties. The core-shell rubber will generally contain about 30 to about 90 percent by weight core, where “core” refers to the central, elastomeric portion of the core-shell rubber. The core-shell rubber may be added after the polymerization is complete, in a high shear environment such as an extruder.

A natural or synthetic rubber is another type of modifier that is useful and may be added to the composition. Rubber is generally added to improve the toughness of the polymer. Rubber modified polymers according to the invention desirable exhibit a dart impact strength (according to ASTM D3763-99) of about 50 inch/lbs or greater, more preferably about 150 inch/lbs or greater and most preferably about 300 inch/lbs or greater.

In addition to the previously-described chain extenders and modifiers, various kinds of optional materials may be incorporated into the polymerization process. Examples of such materials include reinforcing agents (such as glass, carbon or other fibers), flame retardants, colorants, antioxidants, preservatives, mold release agents, lubricants, U stabilizers, and the like.

The resulting polymer is useful in applications such as automotive body parts, appliance housings and other applications in which engineering polymers are useful.

The following examples are provided to illustrate the invention, but are not intended to limit the scope thereof. All parts and percentages are by weight unless otherwise indicated.

### EXAMPLE 1

0.25 part of a bishydroxyethyl, methyl, tallowalkyl ammonium-modified montmorillonite clay (Cloisite™ 30B, from Southern Clay Products) and 4.73 parts of cyclic butylene terephthalate oligomers are weighed into a glass vial. 0.0198 parts of distannoxane catalyst are then added, followed by 10 parts of methylene chloride. The vial is then capped and placed on an orbit shaker for several minutes until the oligomers are dissolved and a homogenized, non-settling, translucent mixture is obtained. The methylene chloride is then evaporated, and the residual powder is dried under vacuum overnight at 90° C. The resulting dispersion contains 5% by weight dispersed clay and 0.15 mol-% catalyst (based on oligomers). Polymerization of the resulting dispersion is performed at 190-220° C. to produce a composite poly(butylene terephthalate) polymer.

### EXAMPLES 2-5

Composite Example 2 is prepared as follows. 15.83 grams of Cloisite™ 30B modified clay is placed in a two-necked flask. 243 mL of o-dichlorobenzene (ODCB) is added and the mixture stirred for about 30 minutes until a uniform dispersion is formed. Another 3 mL of ODCB is added as a rinse. 300 g of cyclic butylene terephthalate oligomers are added. The flask is then heated to 160° C. and stirred for about 30 minutes to form a solution of the oligomers in the ODCB and to disperse the clay into the resulting solution. Butyl tin dihydroxy chloride (1 g) is added and the mixture is stirred for one minute. The mixture is then heated at 190° C. for 90 minutes polymerize the oligomers and then cooled to room temperature. The weight average molecular weight of the resulting polymer is about 73,000.

Composite Example 3 is prepared in the same manner, except 33.44 g of the clay are used. The weight average molecular weight of the resulting polymer is about 38,000.

Composite Example 4 is prepared in the same manner as Composite Example 2, except a similar amount of a methyl, cocoalkyl, bishydroxyethyl ammonium modified synthetic fluormica clay (Somasif™ MEE, from Co-op Chemical) replaces the Cloisite 30B clay, and the polymerization is conducted for 120 minutes. The weight average molecular weight of the resulting polymer is about 64,000.

Composite Example 5 is prepared in the same manner as Composite Example 4, except 33.48 g of the clay are used. The weight average molecular weight of the resulting polymer is about 47,000.

Tensile modulus, % elongation, distortion temperature under a 66 psi (455 kPa) load and coefficient of linear thermal expansion (over a temperature range of 22-80° C.) are measured on test parts that are injection molded from each of Nanocomposite Examples 2-5. Results are as given in Table 1.

TABLE 1

| Example | Tensile Modulus, | % | DTUL, | CLTE, |
|---|---|---|---|---|
| No. | psi (GPa) | Elongation | ° F. (° C.) | cm/cm/C × 10⁻⁶ |
| 2 | 480,000 (3.31) | 1.1 | 354 (171) | 98 |
| 3 | 450,000 (3.10) | 0.2 | N.D. | 89 |
| 4 | 470,000 (3.24) | 0.8 | 350 (177) | 84 |
| 5 | 490,000 (3.38) | 0.5 | 367 (183) | 81 |

N.D.—not determined.

### EXAMPLES 6-9

Composite Example 6 is prepared by charging 15.85 grams of Cloisite™ 30B modified clay into a two-necked flask. 243 mL of o-dichlorobenzene (ODCB) are added and the mixture stirred for about 30 minutes until a uniform dispersion is formed. Another 3 mL of ODCB is added as a rinse. 300 g of cyclic butylene terephthalate oligomers are added. The flask is then heated to 160° C. and stirred for about 30 minutes to form a solution of the oligomers in the ODCB and to disperse the clay into the resulting solution. Butyl tin dihydroxy chloride (1 g) is added and the mixture is stirred for one minute. The mixture is then heated at 190° C. for 120 minutes to polymerize the oligomers, after which it is cooled to room temperature. A solid solution of polymer containing dispersed clay particles is formed, the weight average molecular weight of the polymer phase being about 72,000. The polymer solution is broken into small particles, placed into extraction thimbles and extracted with chloroform for 16-24 hours to remove the ODCB. The residual nanocomposite is then dried, ground in a Wiley mill, and heated under vacuum for 210° C. and ˜1 mm Hg vacuum (˜133 Pa) for eight hours to perform a solid state polymerization. The weight average molecular weight of the polymer phase following the solid state polymerization is about 155,000.

Composite Example 7 is prepared in the same manner, except 33.43 g of the clay are used. The weight average molecular weight of the resulting polymer is about 35,000 before solid state curing and about 73,000 afterwards.

Composite Example 8 is prepared in the same manner as Composite Example 6, except a similar amount of Somasif™ MEE clay replaces the Cloisite 30B clay. The weight average molecular weight of the resulting polymer is about 52,000 before solid state curing and about 145,000 afterwards.

Composite Example 9 is prepared in the same manner as Composite Example 8, except 33.43 g of the clay are used. The weight average molecular weight of the resulting polymer is about 39,000 before solid state curing and about 104,000 afterwards.

Heat sag (at 170 and 210° C.), tensile modulus, % elongation, distortion temperature under a 66 psi (455 kPa) load and instrumented impact strength are measured on test parts that are injection molded from each of Composite Examples 6-9. Results are as given in Table 2.

TABLE 2

| | Heat Sag | Tensile | % | | Instrumented |
|---|---|---|---|---|---|
| Example | @ 170/ | Modulus, | Elon- | DTUL, | Impact, |
| No. | 210° C., mm | psi (GPa) | gation | ° F. (° C.) | lb-in (N-m) |
| 6 | 2.6/4.1 | 480,000 | 3 | 339 (171) | 20 (2.26) |
| | | (3.31) | | | |
| 7 | 1.8/2.8 | 610,000 | 0 | 354 (179) | 4 (0.45) |
| | | (4.21) | | | |
| 8 | 2.7/3.7 | 480,000 | 2 | 338 (170) | 20 (2.26) |
| | | (3.31) | | | |
| 9 | 1.1/2.7 | 550,000 | 2 | 358 (181) | 5 (0.56) |
| | | (3.79) | | | |

It will be appreciated that many modifications can be made to the invention as described herein without departing from the spirit of the invention, the scope of which is defined by the appended claims.

1. A process for preparing a dispersion of filler particles in a polymer of a macrocyclic oligomer, comprising
a) combining filler particles, macrocyclic oligomer and a solvent for the macrocyclic oligomer, under conditions such that the macrocyclic oligomer is dissolved in the solvent, to form a mixture of filler particles dispersed in the macrocyclic oligomer and solvent;
b) polymerizing the macrocyclic oligomer in the presence of the dispersed filler particles.

2. The process of claim 1, wherein the dispersed filler particles have a smallest dimension of about 0.6 nanometer to about 50 nanometers.

3. The process of claim 2, wherein the filler particles are particles of a layered clay.

4. The process of claim 3, wherein the clay is modified with an organic onium compound.

5. The process of claim 1, wherein the mixture contains from about 1-10% by weight of the filler particles, based on the combined weight of the filler particles, macrocyclic oligomer and any co-monomer, chain extender, polymer, impact modifier or rubber that is present.

6. The process of claim 1, wherein the mixture of filler particles dispersed in the macrocyclic oligomer and solvent further contains one or more of a co-monomer, chain extender, polymer, impact modifier or rubber.

7. The process of claim 1, wherein the mixture of filler particles dispersed in the macrocyclic oligomer and solvent contains from about 25-75% by weight solvent.

8. The process of claim 1, wherein the solvent is removed prior to step b).

9. The process of claim 1, wherein the filler particles and macrocyclic oligomer are subjected together to high shear conditions.

10. The process of claim 3, wherein the filler particles and macrocyclic oligomer are subjected together to high shear conditions.

11. The process of claim 10, wherein the filler particles and macrocyclic oligomer are subjected to high shear conditions in the presence of the solvent.

12. The process of claim 11, wherein the solvent is removed after subjecting the filler particles and macrocyclic oligomer to high shear conditions but prior to step b).

13. The process of claim 10, wherein the solvent is removed prior to subjecting the filler particles and macrocyclic oligomer to high shear conditions.

14. The process of claim 13, wherein the filler particles and macrocyclic oligomer are subjected to high shear conditions during step b).

15. The process of claim 14, wherein solvent is removed after step b).

16. The process of claim 15, wherein the polymerized macrocyclic oligomer is further processed to increase molecular weight.

17. The process of claim 1, wherein step b) is conducted in the presence of the solvent.

18. The process of claim 17, wherein the filler particles and macrocyclic oligomer are subjected to high shear conditions in the presence of the solvent.

19. The process of claim 18, wherein the filler particles, macrocyclic oligomer and solvent are subjected to high shear conditions during step b).

20. The process of claim 19, wherein the solvent is removed from the polymerized macrocyclic oligomer.

21. The process of claim 20, wherein the polymerized macrocyclic oligomer is further processed to increase molecular weight.

22. The process of claim 18 wherein the polymerized macrocyclic oligomer is further processed to increase molecular weight.

23. The process of claim 18, wherein the filler particles, macrocyclic oligomer and solvent are subjected to high shear conditions prior to step b).

24. The process of claim 18, wherein step b) is conducted at a temperature of not greater than 190° C.
